(19) United States
(12) Patent Application Publication
(10) Pub. No.: US 2006/0231040 A1
(43) Pub. Date: Oct. 19, 2006

(54) Pet drinking jar for receiving and opening a closed beverage can

(75) Inventors: Bertold Bast, Bonn (DE); Jan Driessens, Maastricht (NL)

Correspondence Address: LEGACY PRODUCTIONS, 7701 PACIFIC AVENUE, BUENA PARK, CA, 90621, US

(73) Assignee: BALL PACKING EUROPE GMBH, Ratingen (DE)

(21) Appl. No.: 10/567,302

(22) PCT Filed: Jul. 12, 2004
(86) PCT No.: PCT/EP04/07685

§ 371 Date: Feb. 6, 2006

(30) Foreign Application Priority Data
Jul. 10, 2003 (EP) 030157861

(51) Int. Cl. A01K 7/00

(52) U.S. Cl. 119/77

(57) ABSTRACT

The invention overcomes drawbacks in feeding a pet (animal). A system is suggested which is easy in operating and obtaining an easy refill, having substantially no spillage of liquid upon serving or preparing. This is provided by a drinking jar system for animals. Said system has a level controlling drinks dispensing portion (2;4,12,13,6), designed to receive a beverage can (1) inserted with a front end portion (1f,1b) downwards. The beverage can is containing as a beverage (1a) one of an animal refreshments, a health drink and a nutrition drink. A drinking portion (3;3a,3b) has an open top (3a) to allow an animal to access the beverage when dispensed from said dispensing portion (2) into said drinking portion (3) through a beverage communicating passageway (7,7a). This channel (7) is between the dispensing and the drinking portion (2,3).

The invention concerns a pet (animal) drinking jar and a can for holding liquid. A drinks dispensing portion is designed to receive a beverage can with a front end portion downwards, said beverage can containing as a beverage one of an animal refreshment, a health drink and a nutrition drink. A drinking portion comprises an open top to allow an animal to access the beverage.

### BACKGROUND

The pet food market is well served with a variety of foodstuff or portioned foodstuff packed in three piece cans and other package means for providing pets with suitable meals at home or out of home, i.e. while travelling. A major design requirement for such is packages is the handling convenience for the pet holder. Convenience typically comprises lightness and unbreakable property of the containers and easy access to the content.

Totally underrepresented in the packaged pet food market are products to satisfy the pet's drinking desire. Refreshment means for the animals are usually limited to serving them water, either from tap or large size bottles. Health & nutrition drinks and such for replenishment of energy etc. are not being offered.

These products would represent a meaningful food complement. Such drinks should preferably be offered in convenient, handy packages, just like the solid food packages. Therefore, single serving sizes are important to prevent contained vitamins and trace elements from deteriorating.

### SUMMARY

A purpose of the invention is to overcome the aforementioned drawbacks in pet feeding. A device is to be suggested which is easy in operating and with an easily obtainable refilling, having substantially no spillage of liquid upon serving or preparing.

A further object of the invention is to provide a suitable and convenient packaging means for holding such drinks, receiving it into a pet drinking jar and featuring the combination with a means for clean and reliable opening of the packaging. This is achieved by a level controlled dispensing of the container content into the drinking jar provided with an opening device acting on the lid of the closed can when inserted in the dispensing part of the jar (claim 1, claim 12, claim 22, claim 41; claim 42).

The packaging means for use with the animal drinking jar is a two-piece metal beverage can as it is commonly used in the human drinks business, but having a closed, non-scored top end (claim 36). The entire device of the invention is still capable of receiving any kind of beverage can format commonly used in the beverage industry.

A DWI beverage can with a domed bottom, a thinner wall and a lid, seamed to an upper wall end, is a well proven package which owns all of the important attributes, i.e. safe product holding due to superior barrier properties and convenience in handling, like easy access to the content and lightness as well as an excellent billboard for marketing information (claim 40). However, the pet drink container of the invention does not have the commonly used, lever assisted, easy open end (e.g. SOT—stay on tab, LOE—large opening end, et al.) but a design which will open by simply inserting the can's front portion into the pet drinking jar section called the “dispensing portion” (claim 37, claim 3, claim 11, claim 19). This is well prepared by prior technical design of the can. When in use, it prevents accidental mixing with beverage packages for human consumption. Such measure is for consumer, especially children's, protection.

The dispensing portion receives the front axial portion containing the lid or end of the can, which is scheduled for opening by the cutting or opening device (claim 3, claim 4). The dispensing portion holds a substantially even/flat vertical wall (claim 6) which is adapted in diameter with respect to the beverage can as described. This wall serves for orientation and lateral supporting of the inserted front portion of the can, the remainder of which is freely exposed and unguided.

The can is inserted upside-down and during insertion, the opening device acts on the closed lid, to open only a portion of this lid (panel). Through this opened portion, the content of the can emerges from the can and is received by the “level control drinks dispensing portion”, which serves for stopping a further flow of the liquid, when a certain level of this drink is reached (claims 5, 21, 25). This level is controlled by the drinking portion which is connected through a walled passageway, such as a “channel”, pipe or duct or open top trench (claims 1, 7, 34, 42, 48), between the dispensing portion and the drinking portion. By way of “communicating pipes”, the level on both sides of the at least partly walled passageway is substantially the same and when the level in the drinks dispensing portion reaches the seam of the can, a seal (hydro seal) closes further air supply into the can and thus stops further emerging of liquid by a building-up vacuum inside the can. The dispensing to the drinking portion through the channel or trench as walled passageway is interrupted until an animal takes out liquid from the drinking portion which is open at the top, to allow said animal to access the beverage over a large surface. Reducing the level of the drinking liquid in the drinking portion, disturbs the steady state of the two equal levels on both sides of the communicating passageway and acts to further supply liquid from the can, when the seal of the liquid touching the seam is opened and the level of the liquid in the plenum (claim 23) is below the seam, allowing air to move into the can again.

A unit, self-contained for use with a standard jar has a dispensing portion and an opening as well as an attachment device, for placing it in all known animal drinking jars. The dispensing portion may have the level control means (claim 44), which operates in a similar way. Into a cylindrically walled portion, the front portion of the can is inserted (upside down), the can is opened by the opening device (claim 46, 47). Terminating the opening action, the seam of the can is stopped by the support means (claim 45) which belong to the level control (claim 44). Locating the seam onto the upper level of the support means prepares the can for a hydro seal, when the level in the drinking jar reaches the level of the seam of the can. Further supply of liquid is then interrupted. In this situation, the liquid is filled into the jar and the attachment device, preferably having at least one suction pad, is fully surrounded by liquid. The attachment devices still keep the self-contained unit fixed in local relation to the jar, where it was applied (claim 43).

To provide for such level control in the jar or the self contained unit, bottom supports are provided on which the seam rests, when the can is put upside-down into the dispensing portion (claims 5, 44, 45). This receiving buffer chamber is a plenum (claim 17, 21, 23 as well as 25), extending between the inserted lid and a bottom wall of the dispensing portion, surrounded by said cylindrical wall, which receives the front portion of the can (claim 6, 42).

The bottom support is designed to stop the front seam end of the can from further moving downwards when the can is pressed onto the cutting and tearing device for opening a part of the lid (claims 11, 46, 47). These bottom supports have an upper level, which in the inserted state of the can is level with the bottom end of the seam (claims 10, 23, 24 and 45). The support portion may be designed as a ring or as several circumferentially spaced studs which protrude from said bottom of the receiving portion of the jar system (claim 10).

Directed into the dispensing portion there is a gap for supplying air near to the bottom of this portion (claim 6). The supplied air is provided for steadily compensating the steady outflow of beverage as long as the level of the beverage in the drinking portion has not yet reached the final steady state level. Having reached this final level, the air supply is (automatically) cut off. This cutting off is achieved by blocking at least a part of the flow path for the air, which streams along the path as “air supply path” as long as it is not interrupted. The air supplying gap which is providing this, is preferably located higher than the finally reached level, having the drinking portion filled to its steady state final level. This is the “second state” of the jar system, when the air supply through the gap is interrupted (claim 35). The “first state” of the jar system is, when the air supply is active and there is a flow path ending near the bottom of dispensing portion.

The guiding of air can be achieved by a circumferential gap (claim 7), which is around the inserted can. It can also be achieved by the upper part of the trench, which is provided as a gap between both portions for drinking and dispensing. The communication path for the liquid is open to the top and serves in the upper part for returning the supplied air near to the bottom of the dispensing portion, whereas in the first state the bottom of the trench is used to allow a flow of beverage into the drinking portion (claim 34). Other measures may be taken for supplying air in the first state of the system, e.g. at least one hole placed higher than the steady state filled level of the drinking portion.

Providing this serves for a steady flow-out of the beverage, when the can is inserted and opened.

To enhance stability and vertical direction of the can, when inserted, the cylindrical wall may extend further up by an additional lateral holding portion (claim 7). This may additionally serve for protecting from a sharp upper cutting edge of the opening device, attached to the bottom of the drinks dispensing and can receiving portion.

The bottom support for resting the can is not circumferentially continuous, to allow fluid to emerge through spaces between support surfaces and the seam of the inserted can. Additionally, the opening device may itself have lateral (radially directed) opening portions or a slit portion, to allow emerging of liquid after opening only a part of the can lid.

The opening portion is fairly small compared to the size of the lid (claim 17, 47) which substantially corresponds in diameter to the opening portion for receiving the beverage can (claim 6).

Still the can, when inserted, has a stable and well-supported seat within the cylindrical wall of the dispensing portion. The momentums for holding the upside-down can are large compared to the diameter of the can, which is exposed above the cylindrical receiving portion and therefore unseated or unsupported there. Supporting forces and lateral holding forces will only be provided via the front axial portion of the can, but still this provided force is sufficient with respect to the cylindrical can to keep the can in its seated position, even in such circumstances, when lateral forces accidentally hit the can wall.

The opening device has a suitable design to enhance the opening action and to reduce the forces of pressing the can into the cylindrical seat of the dispensing portion (claims 11, 13, 14, 18, 20 and 47). It has an at least partly curved top cutting portion (claim 13), extending from the tip downwards. This cutting portion acts like a knife cutting through the sheet of the lid, when inserted into the receiving portion. As the angle of inclination of this cutting portion increases (claim 14), the cutting force is at maximum at the time of piercing through the can lid with a steep and sharp tip and continues to be lowered until a portion of the opening device is reached which has no cutting edge, but a pushing edge, which is non-cutting but tearing the sheet metal. It acts like a blunt pusher, tearing substantially along the line, along which the blade has previously cut through the tin, but pushes the open portion into the can by bending it into the can and therewith allowing a larger opening, which is not blocked by a lid portion (claims 11, 47).

This is comparable to an action a user may take when tearing an opening portion out of the lid or when pressing an opening portion into the can by using an axially directed force, not only tearing the lid portion along a scoring line, but also hinged moving the lid segment axially into the can.

Both actions of cutting and pushing the lid segment into the can by bending it are performed by the opening device, provided near the bottom of the substantially cylindrical receiving wall in the dispensing portion of the jar.

Special design for the change of inclination and the initiating and ending angle may be used (claim 15 to 17). The cutting edge in other words is steeper in the beginning and becomes less steep, when it approaches the non-cutting portion of the opening device.

To further enhance the removal of the can and the forces necessary to remove the can from the opening device, it may have a shape in which it's substantially tubular shape has a slanted wall towards the inner axis to have a larger diameter on the base than on the top of the opening device (claims 30 to 32). The sharp cut edge of the lid opening does not slide nor block at the opener's outer surface when the can is being removed. From the first initial piercing into the lid until the removal of the emptied can, easy operation as well as a reduction of potential injuries is available. The opening of the can is provided by an esthetical cutting, a clean cut edge is provided, a fully emptying is achieved and the lid segment stays hinged to the remaining lid through a bent portion, minimizing a danger of injury. Provided therewith is a clean, convincing operation with full physical effect of gained achievements.

To enhance flow through the communicating passageway, the bottom Of the receiving portion may be designed with a slope (claim 26), continued through either the bottom of open top trench (claim 8) or a channel pipe.

The whole jar may be covered by a hood, which clamps near the bottom of the jar, to allow carrying the jar and the hood together by means of a handle (claims 27, 28). The system as such may be made of steel, painted or stainless, as well as aluminum or plastics. The hood is made preferably of plastic material.

The beverage can used with the jar does not provide for an opening system attached to the lid (claim 36, 37), the lid itself may also be made from thinner sheet, as no mechanical operation is done to the lid, except the seaming of the shell to the wall of the body. Preferred therefore is a lid made of steel (claims 38, 39). Decoration may be provided upside down as the can is used (claim 40). Preferably, pictures of animals are shown on the decoration of the can.

### BRIEF INTRODUCTION TO THE FIGURES

FIG. 1 is a side view in vertical section of one example of the jar system, when a drinks can 1 is inserted into the dispensing portion 2, which communicates by a channel 7 with a drinking portion 3, open to the top.

FIG. 2 is an enlarged view of the portion identified in FIG. 1, shown in vertical section and lining out in more detail the dispensing portion [2] providing the opening of the can which is identified 50 in FIG. 1, and the level control which is identified by the level height L when compared to the base level L0, as is the bottom wall 3b of the drinking side 3.

FIG. 3 explains a further embodiment of the dispensing portion [2].

FIG. 4a is an enlargement of an opening device 8 in a side view and applied to a bottom 6b of the dispensing portion of FIG. 3.

FIG. 4b is an opening device 8 when applied to a bottom 6b according to FIG. 2.

FIG. 5 is a schematic view of assembling an opening device 8, and a bottom support 12 into the dispensing portion 4.

FIG. 5a displays a side view of a preform of an opening device 8 when in a flat condition.

FIG. 6 displays an alternative way of assembling using a different opening device 8*.

FIG. 7 is a sectional view of a self-contained unit for attaching to a standard jar. The can is shown in phantom, how it would be placed into this device, when opened.

FIG. 7a is a bottom view of the self-contained device as shown in FIG. 7, in a perspective view, assembling suction pads [15] to the lower side of the bottom wall 6b.

FIG. 8 is a plan top view of a further embodiment of the jar system, embodying a gap as a trench 7a between the dispensing portion 2 and the drinking portion 3, open to the top (only partly shown).

FIG. 8a is a side sectional view of the further embodiment, having the trench 7a, which has a bottom portion starting at the lowest end of the bottom 6b of the dispensing portion and directed in a sloped manner to the bottom 3b of the drinking portion.

### DETAILED DESCRIPTION OF EMBODIMENTS

The Embodiments are meant for supporting and enabling the invention.

The entire device comprising components, which act as a functional system fulfilling all of the requirements needed for the purpose of the invention.

The components are individually explained, but may be used in arbitrary combination.

A pet drinking or feeding jar is designed to provide an integrated structure for housing the cylindrical can 1 in a cylindrical can receptacle 4. An opening mechanism 8 and the dispensing 7 and level control volume 6 are provided. The jar design allowing a maximum of shape and contour freedom and holding the can receptacle, the opening mechanism and the dispensing and level control part, all serving the purpose of the invention.

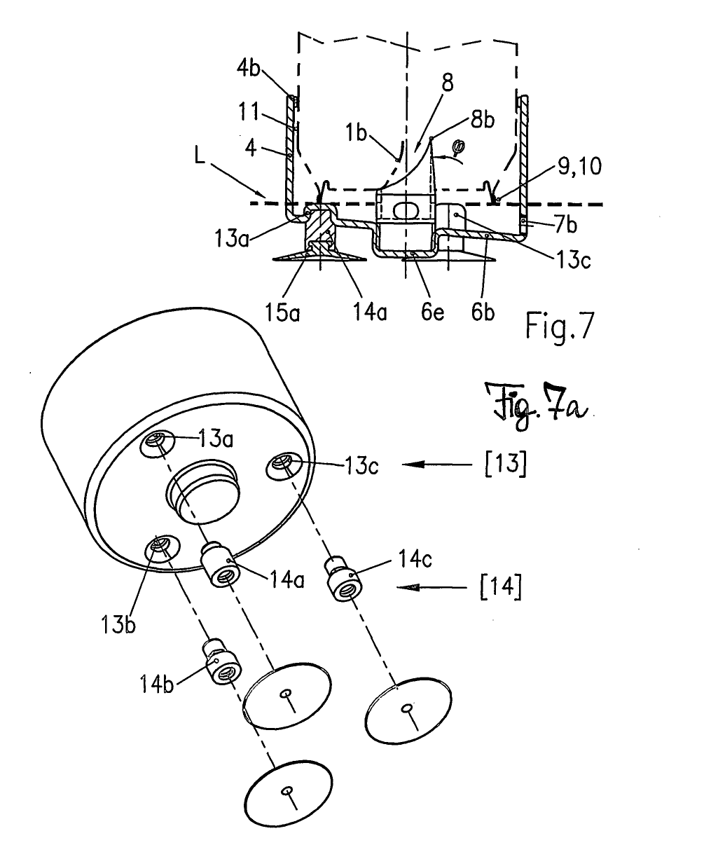

A shallow bottom jar of sufficient size, as commonly used for pet feeding, may as well be used in which case the functional components for holding the can, the opening mechanism and the dispensing and level control part are provided as a self-contained unit according to FIGS. 7, 7a featured with a fastening help such as at least one suction pad 15a, 15b, 15c at its base for fixing the unit to the bottom of the jar.

Anyone of the three designs (new, a redesign and a supplemental unit) meets the expectations set by the purpose of the invention.

A standard two-piece metal beverage can 1 holding a drink 1a which may be one of a variety of kinds. Fitting can formats are all of those being on the market today. They include, but are not limited to, body diameters ranging from “211” size (66 mm) down to “200” (50 mm) with neck diameters 202 (52 mm) or 200 (50 mm) and fill volumes between 150 and 568 ml, and other sizes, when an appropriate diameter adapter is being used, whereas any can height may be used with the jar system without the need for using a can height adapter.

The standard two-piece metal beverage can 1 may be the type as commonly used for passive packaging of “single serve” human drinks with or without additional external features attached to it.

The two-piece beverage can 1 may also be featured with—non-displayed—internal provisions placing the package into the category of “active packaging” by use of multi-compartment concepts. Exemplary applications use single or multi-compartment can inserts, known as “widgets”, “wedges” (floating or fixed), “fresh can” and others, that self-open at the time of opening the can in preparation for consuming its content.

Mechanisms achieved by such features are mixing of compartment contents, adding ingredients, agitating the fill product, or heating or cooling it.

A standard can end 1b (the lid) of reduced design, is characterized by the absence of any score lines and opening mechanism as applied to standard beverage can ends known on the market.

The can end 1b is to fit the chosen (reduced) can neck diameter. The can end may be made from organically coated steel, uncoated tinplate or organically coated aluminium. The organic metal coatings may be based on thermosetting or thermoplastic resins. The can end coatings may be with or without tinting or pigmentation.

The can end metal thickness may range between 0.12 mm and 0.28 mm in case of a steel end (lid) and 0.15 mm and 0.35 mm for an aluminium end (lid).

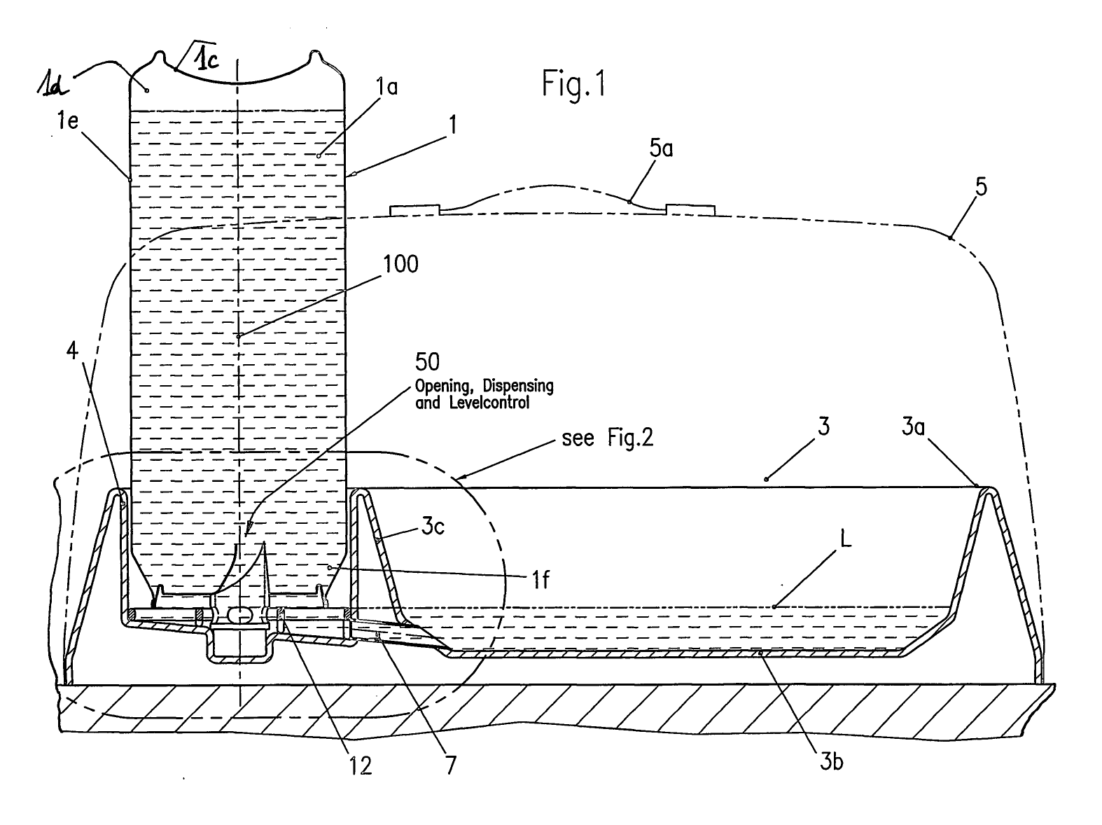

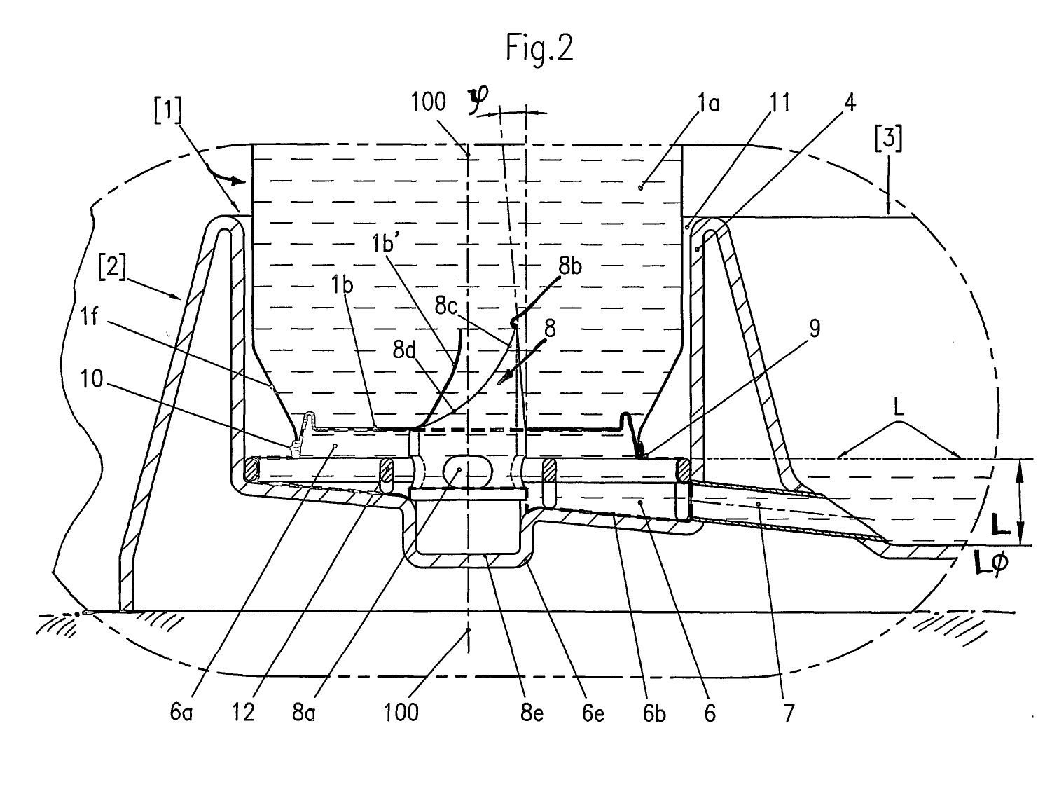

The displayed can 1 as explained above is shown upside down, when already inserted according to FIG. 1 into the dispensing portion 2, having the receiving portion 4 which is a cylindrical wall, adapted to the diameter of the can, for receiving the front part, which is close to the lid 1b. More detailed, the front part 1f is shown in FIG. 2. The back end of the can, which is the bottom end of a regular can, is domed 1c, leaving a head space 1d between the upper level of the liquid 1a and the inside surface of the bottom of the can. The regular top of the can is inserted into the receiving portion 4, where it is displayed that the can has a lid 1b, having a surrounding groove and a seam 10 which would regularly be a double seam, seaming the can lid—having the panel portion and being constituted without any opening system attached to it (shell)—to the necked-in portion of the can wall 1e. The wall 1e and a domed bottom 1f result from the manufacturing of a DWI-can, having a greater wall thickness in the bottom 1c and a reduced wall thickness in the lateral wall portion 1e due to the manufacturing process.

When the can is purchased by the user, the outside decoration of the can (placed within the surface extension of the previously addressed billboard) may present anything that is related to animals and use for such animals. The outside decoration may be upside down, to have a picture presented in regular orientation, when the can is inserted into the receiving portion 4. This may also be the way of displaying it in the shelf of a store, still allowing stacking of the containers, their lids directed downward.

Opening of the can (generally 50) for gaining access to its content is performed by a separate opening device 8 which is integrated into the entire dispensing device 2, 4, when the can is pushed into the receiving portion 4, opening and dispensing part of the liquid to the drinking jar portion 3a through a channel 7, shown as a pipe in FIG. 2.

The can end opening device 8, made from ceramics or metal in part or in total, is provided in the base 6b of the can receptacle 4, which is part of the entire pet drinking device. The can end is opened by introducing the can in upside-down orientation into the can receptacle and then pushing it further to meet and protrude over the can end opening device for breaking into the end panel and generating an opening portion (as a lid segment), allowing the can content to exit the can. The opener 8 has a bent, preferably circular blade for cutting into the can lid 1b, the blade being designed to have a peak portion 8b to reduce the force for breaking the lid, as shown in FIGS. 2, 4a and 5.

The can opening device 8 comprises of a tubular part ending in an upper edge sharpened and extending with a declining angle of between 10° and 80°, preferably between 15° and 70°, referring to the centre axis 100 of the tubular part 8. The angled portion at the upper acting end of the tubular part may extend along the entire circumference of the tubular part or over any fraction (of the cross-section) with the remaining portion containing different shapes to clear away from the tip and the cutting blade of the tubular part.

The cutting end of the tubular part 8 is facing towards the panel of the can end 1b and centres by match of its centre axis 100 with that of the opening panel of the can end. The middle of the tubular part 8 contains window-like lateral openings 8a allowing the liquid product to exit the can. The can-opening device is also fixed to the base 6b of the device, as will be explained later.

The tip 8b of the angled portion of the tubular part 8 serves the purpose of applying a perpendicular force to the can end 1b for opening. Opening of the can end is performed by means of pushing the end panel axially towards the tip of the stationary angled portion of the tubular part. The resulting force between the tip and the opening panel of the end breaks the end panel by cutting through the metal. By doing this, it opens a portion of the can end. Continued axial downward movement of the can makes the opening panel penetrate over the stationary tip while the tip protrudes into the can. It continues to cut the segment 1b′ of the panel leaving a sufficient opening in the can end at the end of its travel, when the double seam 10 is meeting the can receptacle's base as spaced studs 13 or grid 12 (their upper level). Based on the principle of the “inclined plane” the tip contour pushes the opening panel into the can during its travel.

The end of the travel is displayed in FIG. 2 when the segment 1b′ is protruding more steeply into the inside of the can and having a smaller angle of inclination than the cutting edge at the plane passing through the axis 100. This originates from a pushing portion 8d, which is displayed in FIGS. 4a, 4b. This pushing portion is below the cutting portion 8c, tearing the lid along lines, which continue the cut lines of the cutting upper edge 8c, but using tearing, thus pushing the opening segment 1b′ steeper into the can by applying axial forces onto it. This enables enlargement of the opening window, through which the liquid may emerge from the inside of the can. It will flow through the axial channel the tubular opening device 8 provides and through the windows 8a, which may be spaced apart circumferentially and provided in an about middle portion of the opening device 8, but the liquid may as well emerge from slit 8g, when the opening device is not fully circumferential as shown in FIG. 5.

The bottom or base portion of the opening device is fixed into a socket 6e which is provided as cylindrical depression in the slanted bottom 6d of the receiving portion 4.

Several embodiments may be provided for the opening device. One device is shown as circumferentially bent or rolled plate which is displayed in a flat condition in FIG. 5a. This shape having the openings 8a above the base 8e and provides the cutting blade 8c in the top as a co-sinusoidal shape of the upper edge. The portion 8d does not have a cutting edge, but is blunt for tearing the segment 1b′ and bending it along a hinge line into the inside. The flat shape is worked into a cylindrical form and will yield an opening device as displayed in FIG. 5 as well as in FIGS. 4a, 4b. When preparing the flat shape of the opening device 8 worked round around a core or a mandrel, not separately shown, a conical shape of the wall may also be included. This will yield a substantially tubular shape, having a slit 8g, which is tapering. This slit is constituted between both free side edges as shown in FIG. 5a. It may have a maximum extension between 3 mm and 5 mm and serves for a conical design of the opening device 8. The tapering towards the top is shaped to have an angle of between 3° to 1° against the axis 100. The diameter of the substantially tubular device in the base 8e is designed larger than the diameter near the top blade portion 8c, which, however, is not fully circular or circumferential, but only has a part circumferential blade portion. The tapered shape of this design is not separately shown in the figures, where a substantially cylindrical shape of this opening device is displayed, but the explanation given here is ment to read on the figures displayed to provide a further embodiment.

FIGS. 4a, 4b show the inserted position, when the base 8e is located in the depression 6e of the bottom 6b. A collar 8f is provided which serves for proper forces to attach this opening device correctly and constantly in an axial orientation. The inclination α of the tip and the continued cutting portion 8c is displayed in FIG. 4b. The angle is steep, namely between 10° and 30°, preferably about 15°, referred to the axis 100 and will come down to an angle of about 60° to 80°, preferably of 70°, near the left displayed side end of the opening device as shown in FIG. 4b. Approximately in the middle portion, near the plane passing through the axis 100 and being perpendicular is to the plane given by the sheet on which FIG. 4b is drawn, the angle is about 45°.

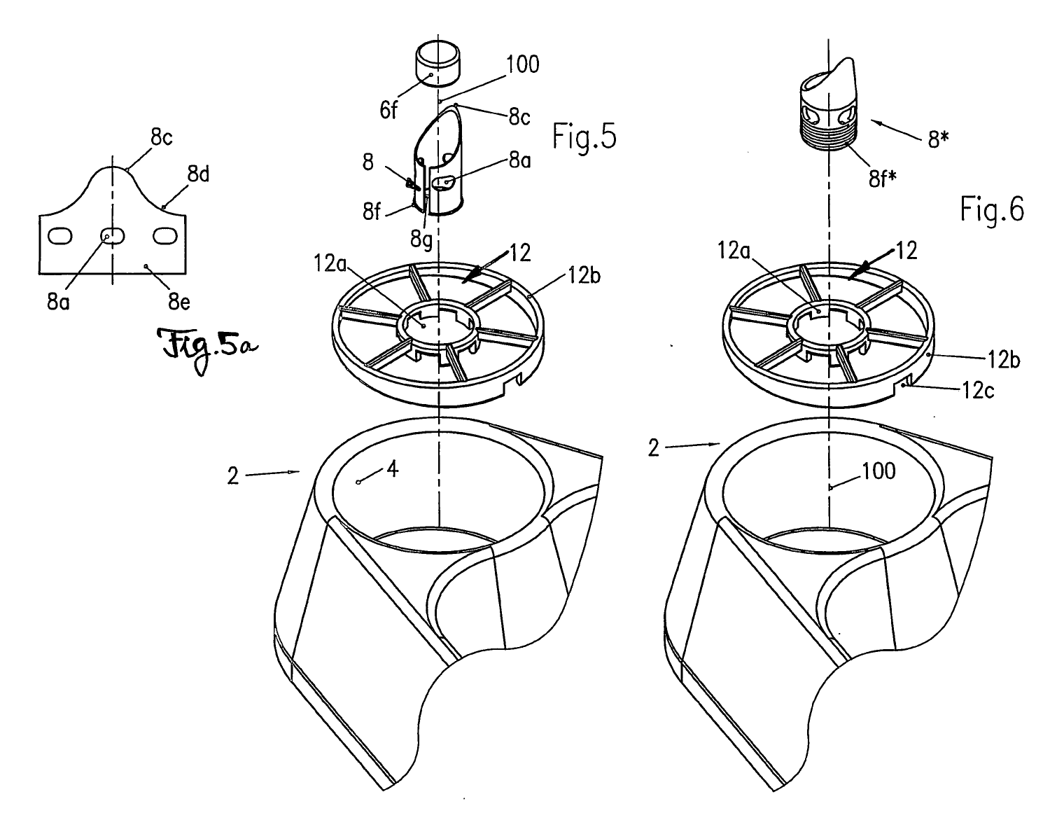

An alternative solution for the opening device 8* is shown in FIG. 6. This is a non-bent, but solid device, having a thread 8f*, which is self-cutting and will grind into the depression 6e, displayed earlier. This is shown in FIG. 2 as an example, also using the grid 12, which has two concentric rings 12a, 12b and star-shaped webs. The outer ring is shaped to follow the slope of the bottom 6b, and the inner ring will allow to pass the thread 8f* through the grid piece 12. The upper edges of the grid 12 define level L as will be explained later. A lateral window 12c is designed for being placed over channel 7.

To enhance the stability of the bent opening device 8 of FIG. 5, an at least partly elastic plug 6f of cylindrical shape is introduced along axis 100 into the centre and below the lateral openings 8a, to allow a tight grip of the collar 8f into the lateral wall of the depression 6e. Apart from this enhanced force, the tapered shape of the opening device is maintained.

To ease the removal of an inserted and emptied can, the opening device 8 or 8* has slanted walls, as seen in FIG. 2 and detailed in FIG. 7 by using the angle φ. This angle is larger than zero, between 3° to 10° and indicates an inside tilted wall (tapered shape), for reducing the forces necessary to remove the cut edge of the panel from the outer surface of the cutting device 8 upon extracting the emptied can. The taper is preferably fully circumferential, but it may as well partly circumferential and the opening device may exhibit a vertical slit 8g.

The effective size and contour of the opening aperture achieved in the can end is crucial to the functionality of the entire device, as are other interacting vent and flow channels described elsewhere. The aperture is preferred to be above 3%, mainly around 5% (±90%), but also up to 20% of the available space of the can lid 1b.

A drink level control is provided to achieve controlled release of the fluid product from the drink container into the jar drinking portion 3 and allow for and maintain a shallow drink level L of predetermined height (level) in the drinking portion 3 above the bottom 3b of the jar until the container 1 is empty. This is to provide drinking convenience for the pet and to prevent excessive splashing and spilling during consumption.

In case of oxygen sensitive drinks, it also reduces the degree of oxidation of the drink that may be caused by prolonged contact of the drink with the surrounding air. Keeping a maximum of the drink for as long as possible inside the controlled environment in the can maintains longer freshness of the product before consumption.

The drink dispensing means 2 utilises the centred, substantially tubular opening of part 8 or 8* furnished with window-like lateral openings 8a along its about middle circumference to guide the fluid content of the can through a level control section at the lower end of the can receptacle 4 and from there through a communicating passageway 7 into the take-away (drinking) portion 3 of the drinking jar. The communicating duct as a channel 7 in FIGS. 1 to 3 is between the level control section and the take-away side of the jar, physically located at a level lower than the bottom rim of the double seam 10 fixing the can end to the can body, when the can is introduced upside down into the can receptacle 4 and resting on either distributed studs 13 or webs of a grid 12.

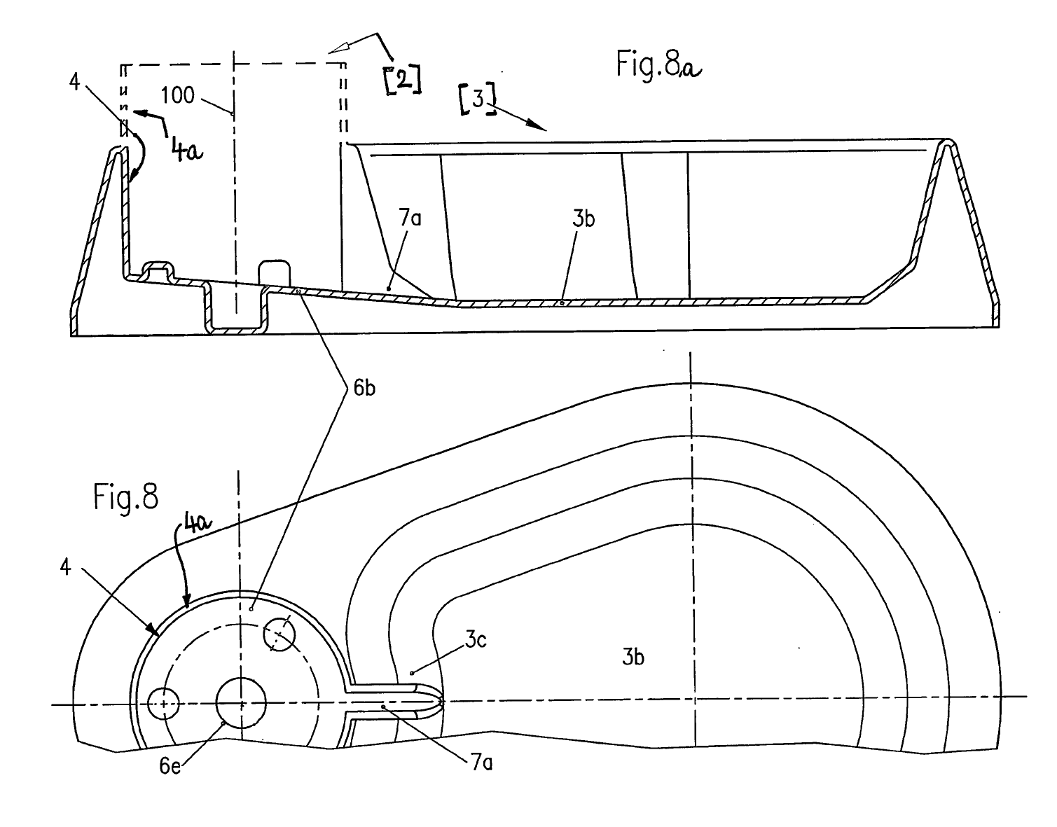

The passageway for communicating the liquid (drink or beverage) into the drinking portion 3 is in a further embodiment designed as a trench 7a, provided as a gap between both portions 4, 3. This is exemplified in FIG. 8, where this trench 7a is provided in the wall segments 3c between both portions. This trench has an open top and a closed bottom, for communicating the liquid like an open top channel. This will later be explained with reference to FIGS. 8, 8a.

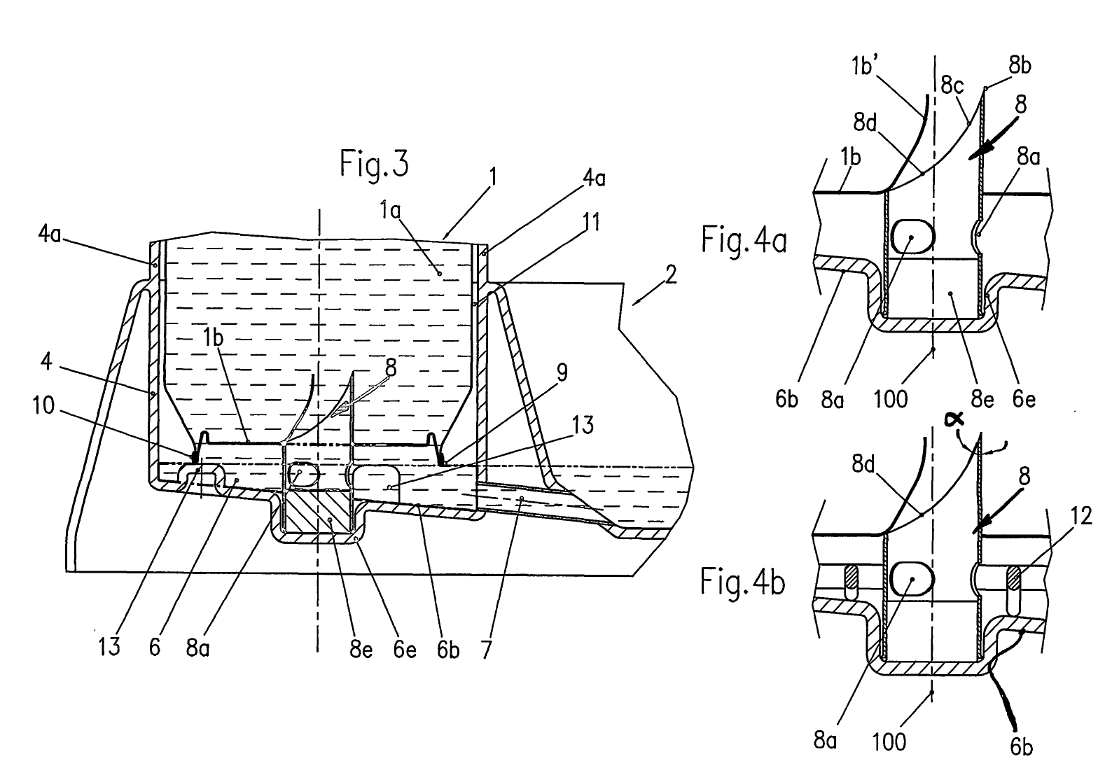

The further embodiment of the level control section is exemplified in the self contained supplemental unit of FIGS. 7, 7a, where the communicating duct is provided as an opening 7b in a lateral wall 4 of the receiving portion 4. This passageway may be present as a hole only, as shown in FIG. 7. This hole may extend upwards to also provide a gap or trench in the lateral wall 4, having a bottom end and open to the top at the upper edge of the wall 4. This will be explained later, with reference to FIGS. 7, 7a. All these embodiments comprise level control sections, as now explained with reference to FIGS. 2, 3, the function of which may be read on all the other embodiments as well.

The level control section is represented by a cavity 6 determined between the bottom 6b of the can receptacle 4, the outer surface of the can lid (panel) and the bottom part of the tubular sidewall of the can receptacle. The inner diameter of the can receptacle is reasonably larger than the outside diameter of the can body to allow easy insertion of the can and to allow surrounding air to enter through a circumferential gap 11 into the level control section.

The dispensing process through the passageway 7, 7a, 7b is interrupted when the content flowing out of the can has filled the level control cavity 6 (the “plenum”) to the level of the rim of the double seam 10 and thus cutting an airflow into the can by hydrosealing 9 the seam to the upper surface level L of either the upper edges of the grid webs or the level of the upper surfaces of the protruding studs 13, spaced apart and extending from the bottom surface 6b. A seal 9 stops the flow of air into the can, to maintain an underpressure in the headspace 1d near the can bottom end 1c.

The dispensing and level controlling mechanism is based on the combination of hydrostatic forces and vacuum forces inside the quasi-closed system. The ratio of the forces is chosen towards both sides of its balance to either allow product release from the can into the drinking jar or to cut the flow of fluid when a predetermined fill level L (above L0) in the drinking portion 3 is reached.

The drinking portion 3 is constituted by a surrounding wall 3c, inclined with respect to a vertical axis. A bottom 3b constitutes together with the surrounding wall 3c a well-portion, which is supplied with liquid through the passageway, below the level L which corresponds to the upper surface of the bottom studs 13 or the upper edges of the grid 12, as explained before. The well 3 is open to the top, indicated by 3a.

The cavity 6 is provided by two portions, a cavity portion 6a which is close to the lid 1b, and a cavity part, which is below the upper level, defined by grid/stud as explained before. The lower part of the cavity continues through the passageway which may be either open to the top as trench 7,7b or a closed pipe 7, connecting the dispensing and control portion [2] and a drinking portion [3].

The cavity acts as buffer storage and is displayed in FIGS. 2 and 3 with dashed lines.

The closed part of the system is represented by the can in upside-down position. The open part of the system is represented by the take-away side 3 of the drinking jar and the level control section of the can receptacle. Although, the can end being opened with the can in upside-down position no product discharge from the can will occur because the gravity force of the product and the vacuum force in the upper headspace 1d of the can are maintained in balance.

However, allowing air to flow into the can will reduce the vacuum in the headspace, and the hydrostatic product force (gravity force) will outperform the vacuum force causing the fill product to discharge from the can. This product flow will continue until the airflow into the can is terminated by the seal 9 at level L and slightly beyond until the balance of forces is re-established.

In the system shown in FIGS. 2 and 7 the air flow into the can is achieved by the path through the gap 11 between the can 1 and the can receptacle 4 continuing through the upper part of the level control section and through the can opening into the can. In the system according to FIG. 8 or the modified system according to FIG. 7 with a trench 7a, the flow of air is provided through the trench, not necessitating a partly circumferential gap 11 between the outer wall of the can and the cylindrical wall 4 of the receiving portion. The return flow of air then is provided above the communicating flow of a beverage along the bottom of the trench. This trench therefore supplies dual functionality, other than the split functionality of channel 7, 7b and air-stream gap 11.

The airflow and thus the product flow is stopped by a back-up effect of the fluid from the take-away portion 3 of the jar through one of the passageways 7, 7a, 7b and into the level control section up to the plane at the (bottom) rim of the double seam 10 of the can. At this stage the fill height at the take-away or drinking side of the jar (the shallow cup-shaped portion) is substantially identical to that of the rim of the double seam.

The product flow-rate of the system may be greater than the rate of drink consumption by the pet at the take-away portion of the drinking jar, if so desired. This will allow satisfying the pet's drinking desire relative to its drinking rate and drinking intervals. The drink level L will be maintained during times of drinking and pausing until the can is empty.

The flow-rate can also be set below the pet's drinking rate causing the pet to almost empty the jar before the predetermined filling level L in the jar is replenished at a low rate. A variation of the flow-rate can be achieved by use of distance pads for raising or lowering the tip 8c of the can lid opening device 8 or 8*.

To keep the circumferential gap 11 in FIGS. 1 to 3 and 7 inside protruding supporting studs 4b as shown in FIG. 7 may be applied near the upper end of the cylindrical wall 4. This equally applies for the self-contained unit shown in FIG. 7 as well as for the units shown in FIGS. 2 and 3. Further, there may be an upper axial extension wall 4a, extending further up the wall 4 which is shown in FIGS. 2, 3 and 8a, to enhance and support stability of the can as inserted into the receiving portion 4 on the dispensing part 2 of the device. The radially inside protruding studs 4b are missing in those embodiments, where an at least circumferential gap 11 is not provided for. This is in those designs, where the trench 7a in either the self contained unit according FIG. 7 or in the drinking jar of FIG. 8 supplies the air in one direction and communicates the beverage in the opposite direction.

With reference to FIG. 7, the self-contained unit is explained, having the dispensing portion 4 as explained before, except that it is not shaped as a one piece part of a jar, but in a separate manner, having a free upper edge near the inwardly directed studs 4b, for laterally supporting the can. All functions and devices are applying equally for this design, except the opening 7b which may just be a hole or window, for releasing the liquid and filling it into a bowl of standard design until the level in this bowl reaches a level L which is shown by the upper surface of the protrusion 13a which supports the bottom end of the double seem of the can 1. This will then provide for a seal as explained before and identified with reference sign 9.

The protrusion 13a may be designed as several circumferentially spaced protrusions 13a, 13b, 13c and used in a dual way by including feet 14a, 14b, 14c in the corresponding bottom of protrusions 13a, 13b, 13c, which are designed as receiver portions when viewed from the bottom as shown in FIG. 7a. The feet [14] continue into suction heads [15] which are fixed to the bottom of the jar, to be filled by the level control self-contained device of FIG. 7.

The opening device 8, the angle of inclination of its cutting and tearing wall 8b, 8c, the attachment of this device in the depression 6e can be taken from the drawing of FIG. 7 and its function may be taken from the prior explanation.

FIGS. 8, 8a show in top view and in a section a design of the jar system with a trench 7a as communicating passageway for liquid in one direction and returning air flow in the opposite direction, to keep the liquid streaming, until the level L as explained before, is hydro-sealing the cans' seam 10, providing a seal 9, to inhibit further flow of liquid and therewith return stream of air.

The trench 7a is vertically oriented, has a closed bottom and may have slightly tapered shape up to the top. It can be described by a deep extension and a small lateral width, open to the top and closed at the bottom end. The bottom end may continue into the slanted bottom wall 6b of the receiving portion (lateral wall 4 surrounding it) and it may be guided directly flushing into the bottom wall 3b of the drinking portion 3 of the jar system. An upper extension 4a of the lateral wall 4 may be present, as shown in the FIG. 3 embodiment.

The trench is through at least one, preferably two, spaced apart walls 3c between the drinking portion and the dispensing portion. In FIG. 8 the depression 6e is exemplified, for housing the opening device 8 and the lateral wall 4, which is cylindrically adapted for a shape of the can to be inserted here.

It is not displayed in FIG. 8, how the can 1 is inserted in the downwards directed manner as shown, for example, in FIG. 1. It is, however, appreciated that there is no substantial air streaming gap 11 necessary between the outer wall of the can and the inner surface of the cylindrical receiving portion 4, as the back air stream is provided through the upper part of the trench 7a. A remaining (minor) circumferential space is for fitting the can into the receiving portion 4 (or cylindrical wall 4, 4a).

The same trench may be embodied into a variant of FIG. 7, which is not separately displayed. The hole 7b provided there in combination with the air stream allowing gap 11 may be modified, to either leave the gap or to remove the supporting studs 4b, to allow a closer coordination of can and receiving portion 4, but including the trench, which starts at the bottom opening 7b and extends axially along the whole wall 4. The trench may also be reduced here to have an elongated hole or opening 7b, which is open at least partly above the indicated level L to allow the return stream of air, until that time, when the seal 9, 10 begins to operate.

Preferably, the opening 7b, an elongated opening (not separately displayed) or the whole trench (not separately displayed) begin near or at the lowest level of the bottom wall 6b, which is indicated to be sloped, to promote a fluid flow from the plenum 6, which was explained earlier. This plenum is the liquid contained in the buffer chamber, which is near, namely above the bottom wall 6b, and the measures for providing return air stream are designed to allow the air to stream near to the bottom 6b. Streaming air therefore is meant to reach near the bottom, into the plenum, until it is not completely filled with liquid and sealed along the rim 10, but is also meant not to allow an outflow of liquid, except there, where the opening 7b or any of the other embodiments of the explained passageway are provided for supplying the liquid into the drinking portion 3,3b.

It is again referred to FIG. 1, showing the hood 5, which is less in height than an inserted can 1 and thus designed to take away and make the device with a dispensing portion and a drinking portion portable. The hood 5 may be designed of plastic material and have a handle 5a, for carrying the whole device. A clipping or snapping connection may be provided at the bottom surrounding end of the hood 5, for connecting it to the bottom end of the device 3, 2.

The position of the windows 8a of the opening device may in axial direction vary between the lid 1b and the bottom level, which is slanted along the bottom wall 6b. It may therefore be either above or below or above and below the upper level of the bottom support 12 or 13.

1. Drinking jar system for animals, said system having
(i) a level controlling drinks dispensing portion (2;4,12,13,6), designed to receive a beverage can (1) inserted with a front end portion (1f,1b) downwards, said beverage can containing as a beverage (1a) one of an animal refreshment, a health drink and a nutrition drink;
(ii) a drinking portion (3;3a,3b) comprising an open top (3a) to allow an animal to access the beverage when dispensed from said dispensing portion (2) into said drinking portion (3) through a beverage communicating passageway (7,7a), preferably a channel (7), between the dispensing and the drinking portion (2,3).

2. System according to claim 1, wherein the dispensing portion (2) has a receiving portion (4) adapted to receive a cylindrical beverage can (1) with no more than the front end portion (1f,1b) thereof, preferably no more than 50%, especially 30% of an axial height of the beverage can.

3. System according to claim 1, wherein the dispensing portion has substantially cylindrical shape, open to the top, at least one bottom support (12,13) and having an opening device (8;8b,8c, 8e; 8*) with a blade, suitable for cutting through only a part of a lid (1b) the can front end portion (1f,1b).

4. System of claim 1, wherein the dispensing portion (2) has an upwards directed, preferably at least partly circular, cutting device (8) for cutting through a part of a lid, a support portion (6e) housing a base (8e) of said cutting device, and a receiving buffer chamber (6) for a dispensed amount of the beverage.

5. System according to claim 4, wherein the communicating passageway (7,7a) is provided from said receiving buffer chamber (6) to said drinking portion (3).

6. System according to claim 1 or 4, wherein the dispensing portion has a substantially cylindrical shape (4) adapted in diameter with respect to a cylindrical beverage can, to leave a gap (11,7a) for supplying air near to a bottom of the dispensing portion (4), preferably into the receiving buffer chamber (6).

7. System according to claim 1 or 6, wherein the dispensing portion has a substantially cylindrical shape (4) adapted in diameter with respect to a cylindrical beverage can, to leave an at least partly circumferential gap (11) between the cylindrically shaped inner wall of the dispensing portion (4) and a wall (1e) of the beverage can, when inserted into the dispensing portion.

8. System according to claim 1 or 6, wherein the dispensing portion has a substantially cylindrical shape (4) adapted in diameter with respect to a cylindrical beverage can, and a trench (7a) is provided as the passageway or gap (11) between the dispensing portion (4) and the drinking portion (3;3a, 3b) comprising the open top (3a), to supply beverage flowing in one direction and air streaming in the opposite direction.

9. System according to claim 1 or 2 or 6, wherein said dispensing portion has at least one lateral holding portion (4,4a, 4b), preferably facing radially inward, for laterally supporting and keeping the adjusted position of the beverage can after having been inserted into the receiving portion (4) of the dispensing portion (2).

10. System according to claim 3, wherein said support (12,13) comprises a support ring (12a, 12b) or several circumferentially spaced protruding studs (13;13a,13b,13c).

11. System according to claim 1, having an at least partly circular cutting device (8;8*) with two portions, for cutting through a relatively small part (1b′) of the lid, the device comprising
(a) a blade part (8c) extending inclined from a top portion (8b) of the cutting device;
(b) a non-cutting remaining portion (8d) below the blade part and having a relatively blunt upper end, for pushing the lid part upwards and bending it into the inside of the can, during a part of a downward movement of the can, until resting on a support (12,13).

12. System of claim 1, wherein said dispensing portion (2;4,6,12,13) has a bottom wall (6b) and an opening device (8) protruding therefrom in an upward direction.

13. System according to claim 12, wherein said opening device (8) comprises an at least partly curved blade (8c), said blade extending inclined from a tip portion (8b) downward.

14. System according to claim 13, wherein the angle of inclination (α) of the inclined blade changes from a small angle to a large angle, the angle being referred to an axis (100) of said at least partly tubular opening device (8).

15. System according to claim 14, wherein said large angle of inclination is in the range of 60° to 80°.

16. System according to claim 14, wherein said small angle (α) is in the range of 10° to 30°.

17. System according to claim 14, wherein the change of angle of inclination of said blade (8b,8c) is substantially smooth.

18. System according to claim 13, wherein a lower portion (8d) is terminating the blade and clearing a cutting portion (8c) from a tearing portion (8d) of said opening device (8).

19. System according to claim 11, wherein said opening device (8,8*) is shaped and adapted to open the small part (1b′) having 20% to 3%, preferably around substantially 5%, of the area surrounded by a vertical wall segment (4) of the dispensing portion, for receiving the front end portion (1f,1b) of the beverage can (1).

20. System according to claim 13, wherein said opening device comprises no more than a partly circumferential blade as top cutting edge of a substantially tubular shaft of the device (8).

21. System according to claim 12 or 3, wherein said bottom support (12,13) has upper stop edges or upper surfaces provided at a first level (L) higher than a second level (L0) of a bottom wall (3a) of said drinking portion (3).

22. System according to claim 3 or 12, wherein said opening device has at least one lateral window (8a) below the blade portion (8c) for supplying fluid emerging from a partly opened lid to a plenum (6) below an upper end level of the bottom support (12,13).

23. System according to the preceding claim, wherein said lateral window (8a) extends above and below the upper end level of said bottom support (12,13) to supply fluid to a space (6) provided as the plenum between the can lid (1b)—when inserted—and the bottom wall (6b) of the dispensing portion.

24. System according to claim 22, wherein the plenum (6) continues through the passageway (7,7*) for supplying the fluid emerging from a partly opened lid to said drinking portion (3) at a level lower than the upper end level of said support (12,13) for a seam (10) of the inserted can.

25. System according to claim 12, wherein said dispensing portion further has a plenum (6) near the bottom end wall (6b) for receiving fluid emerging from a partly opened can lid (1b).

26. System according to claim 25, wherein said bottom wall (6b) is sloped towards the passageway (7,7*) between said dispensing and drinking portions (2,3).

27. System according to claim 1, having a detachable hood (5), surrounding and covering in a closed position both, the dispensing portion and the drinking portion.

28. System according to claim 27, wherein said hood has a handle (5a).

29. System according to claim 3, 4, 11 or 12, wherein said opening device (8,8*) is made at least in part of metal or ceramics.

30. System of claim 10 or 29, wherein said opening device (8,8*) being at least in part tapered (φ) or having a slanted wall, slanted towards an axis (100) of said opening device, to have a larger diameter at a base (8e) than at a top (8b) thereof, preferably having a taper angle of between 3° to 10° against the axis.

31. System of claim 30, the device (8,8*) having a substantially vertically oriented slit (8g), narrowing or tapering towards the top (8b).

32. System of claim 31, the tapering slit (8g) having a maximum width of between 3 mm and 5 mm.

33. System according to claim 1, wherein the two portions (3,2) of the system are made at least in part of painted steel, stainless steel, aluminium or plastics.

34. System according to claims 1 or 5, the communication passageway being shaped as a trench (7a), open to the top and having a closed bottom path.

35. System according to claims 1, 6 or 34, having an air supply (7a, 11), adapted for conducting air into the dispensing portion and into an inserted, opened can (1,1b′) in one state of the jar system, and for stopping air supply in a second state of the jar system.

36. Beverage can for use with a drinking jar system according to claim 1, said can comprising
(a) a one-piece can body having a domed bottom (1c) and an integrally formed cylindrical side wall (1e) surrounding an inside, said bottom having a thickness greater than said wall;
(b) a lid having panel portion (1b), attached through a seam (10) to said integral wall, wherein said panel portion is closed and has no score lines adapted for breaking a portion or segment of the lid into the inside of the can body and/or wherein no opening device is attached to the panel portion.

37. Beverage can according to claim 36, wherein said lid and said panel portion constitute a shell without an attached opening system.

38. Beverage can according to claim 36, wherein said lid is made from sheet metal in a thickness between 0.10 mm to 0.28 mm.

39. Beverage can according to claim 36 or 38, wherein said metal is steel or aluminium.

40. Beverage can according to claim 36, wherein the one piece can body comprises, preferably upside down, an outside decoration identifying use for animals, or at least one animal picture.

41. Drinking jar system for animals, said system having a beverage dispensing portion (2;4,6),
having received
or
designed to accept
a beverage can (1) with an axial portion (1f)—having an end (1b)—downwards,
said system further having a drinking portion (3) comprising an open top (3a), allowing the animal to access a beverage when dispensed from said dispensing portion (2) through a passageway (7,7*) between the dispensing and the drinking portion (2,3) into said drinking portion.

42. Self-contained unit for supplementing into or complementing a known or commonly used animal drinking jar, the unit comprising
(i) a dispensing portion (2) having a wall portion (4) for receiving at least an axial part of a beverage can, said wall portion having substantially cylindrical shape;
(2i) a lateral opening (7,7b), preferably a gap, for connecting said dispensing portion to a drinking portion of said drinking jar;
(3i) an attachment device (13,14,15) for attaching said unit to the bottom of said drinking portion of said drinking jar.

43. Unit according to claim 42, wherein the attachment device has at least one suction pad (15,15a), for attaching it to the drinking jar.

44. Unit according to claim 42, wherein said dispensing portion has a level control means (13,9,10) for blocking further flow of beverage from an inverted can, when a certain level (L) in said drinking portion is reached, and for releasing further discharge from said beverage can, when a level of beverage is below said certain level.

45. Unit of claim 44, wherein an upper end of a support means (13) of said level control means is located above or higher than a bottom wall (6b) of said dispensing portion (2;4).

46. Unit of claim 42, wherein said dispensing portion (2;4) has a bottom wall (6b) and an opening device (8) protruding therefrom in an upward direction.

47. Unit according to claim 46, wherein an at least partly circular cutting device (8;8*) as opening device for cutting through a relatively small part (1b′) of the lid has two portions
(a) a blade part (8c) extending inclined from a top portion (8b) of the cutting device;
(b) a non-cutting remaining portion (8d) below the blade part and having a relatively blunt upper end, for pushing the lid part upwards and into the inside of the can, during a downward movement portion of the can, prior to resting on the support (12).

48. Unit of claim 42, the opening (7b) having a height and a width, the height being larger than the width, preferably as a trench in the wall portion, the trench extending downwards to the bottom wall (6b) of the dispensing portion (2,4).
